(19) United States
(12) Patent Application Publication
(10) Pub. No.: US 2012/0016597 A1
(43) Pub. Date: Jan. 19, 2012

(54) METHOD FOR GAS CHROMATGRAPHY ANALYSIS AND MAINTENANCE

(76) Inventor: Anwar Sutan, Aberdeen (GB)

(21) Appl. No.: 12/908,569

(22) Filed: Oct. 20, 2010

(30) Foreign Application Priority Data
Jul. 15, 2010 (GB) 1011921.2

(51) Int. Cl. G06F 19/00

(52) U.S. Cl. 702/24

(57) ABSTRACT

A method of analyzing gas chromatography data may include acquiring response factor data for each of a plurality of compounds included in one or more calibration gas samples from a gas chromatograph apparatus, and determining a correlation with molecular weight data for each of the plurality of compounds. The correlation may be analyzed to determine a condition of the gas chromatograph. The method may also determine a correlation for each of a plurality of operating phases of the gas chromatograph, for example, before and after actuation of valves which change the flow rate. The method may also include diagnosing faults, and calibrating and configuring gas chromatographs.

### FIELD OF THE INVENTION

The present invention relates to the field of gas chromatography, and, in particular, to a method of analyzing gas chromatography data, and methods of calibrating, monitoring, and/or maintaining gas chromatography equipment.

### BACKGROUND TO THE INVENTION

Gas chromatography (GC) techniques are used in analytic chemistry applications to separate and/or analyze components of a mixture. Gas chromatography uses a carrier gas as its mobile phase, and a layer of liquid or polymer on a solid support as its stationary phase, located in a metal tube referred to as a column. Gaseous compounds in a sample being analyzed interact with the stationary phase as it passes through the column with the carrier gas. Different compounds interact at different rates and elute at different times. Analysis of the retention times of the compounds allows information to be derived about the compounds.

Gas chromatography has numerous industrial applications. For example, it may be used in the oil and gas industry to analyze the composition of a natural gas, which typically includes inert components and hydrocarbon components ranging from C₁ to C₇+: i.e. Nitrogen, CO₂, methane, ethane, propane, isobutane, n-butane, isopentane, n-pentane, hexanes, heptanes and higher alkanes. To analyze such a sample in a practical time frame and without temperature ramping, a multi-column separation technique is desired. A C₆+ GC system is configured to analyze components from C₁ to C₅ separately, with C₆ and higher compounds giving a single output. A C₇+ GC system may be configured to analyze components from C₁ to C₆ separately, with C₇ and higher compounds giving a single output.

A typical three column GC design 100, is shown in FIG. 1 and uses three six-port chromatograph valves 101, 102, 103, three columns 111, 112, 113, a restrictor 104, a reference detector 106, and a measuring detector 107 in a controlled temperature chamber 108. The detectors 106, 107 are thermistors, where resistance changes depend on the temperature. The reference and measuring detectors form a balanced Wheatstone bridge. Helium may be the preferred carrier gas because it has a relatively high thermal conductivity, although Nitrogen, Hydrogen, and Argon may also be used in special circumstances. FIG. 1 shows a flow path of the C₁, C₂, C₆ compounds through the third column 113.

With only carrier gas flowing across the two detectors 106, 107, the Wheatstone bridge may be in balance. In the measuring detector, the sample gases passing across the thermistor may cause thermal conductivity changes, which may result in a change of the thermistor heat exchange rate. This, in turn, results in an increase of the temperature of the thermistor. The change of temperature may result in a change of resistance in the measuring detector and may unbalance the Wheatstone bridge. The magnitude of the voltage created by the unbalanced bridge and the time taken to pass through the detector then forms a response curve proportional to the amount of the component in the carrier gas stream.

Actuation of the valves controls the flow of gases in the GC. There are three valve timings on the three-column chromatograph as follows: First, valve 112 is actuated to allow the heaviest component (C₆+ in a C₆+ GC application, or C₇+ in a C₇+ GC application) to be back-flushed. The back-flush is initiated after C₅ and lighter components (in a C₆+ GC system), or after C₆ and lighter components (in a C₇+ GC) are eluted from columns 111 and 112, but before the heaviest component (i.e. C₆+ or C₇+) leaves column 111. Secondly, valve 113 is actuated to trap the light components in column 113. The valve actuation has to be after all C₂ (ethane) is eluted into column 113, but before any C₃ (propane) leaves column 112. Thirdly, valve 113 is actuated to allow light components to leave column 113. The valve actuation has to be after all the middle components (C₃ to C₅ in a C₆+ application; C₃ to C₆ in a C₇+ application) clear the measurement detector.

During calibration, a calibration gas of known composition is analyzed. The gas chromatographs (GCs) analyze the sample, and the components of the composition generate peaks in the output of the detectors. The area measured under the peak is divided by the known gas molar percentage of that component to derive a response factor for that component. That is, the response factor RF is calculated as follows:

RF=Peak Area/Gas mole %

During normal analysis of an unknown sample, the response factor RF is used to calculate the unknown gas mole percentage of each component from the measured peak area and the response factor, according to

Gas mole %=Peak Area/RF

Gas chromatographs are typically delivered from a factory with a multilevel calibration already programmed. The multilevel calibration may be performed on a number of separate gas samples corresponding to the compounds that the gas chromatograph is configured to detect. While this may be an effective method to handle the linearity of the detector, many sets of gases at varying concentrations are desired to obtain the multilevel calibration parameters. It is common for component parts of the GC, such as columns, diaphragms, detectors, etc., to be changed on site, after which the GC may require a new set of multilevel calibration parameters. For a number of reasons it may not be practical to perform multilevel calibration on site or in the field because of the time consuming nature of a multilevel calibration process.

Other calibration techniques may be used in the field. For example, a periodic auto-calibration may be performed using a certified gas sample mixture to ensure that the GC is functioning within a defined specification. The frequency at which the calibrations are performed is determined by the stability of the GC calibration, and may, for example, be daily, weekly, or monthly. A calibration report may be generated after each calibration cycle and provides response factor data from the previous calibration and new response factor data from the current calibration. A slight shift in the response factor may be acceptable, as defined in standard ASTM D7164-05 (See for example, ASTM D7164-05, Standard Practice for On-line/At-line Heating Value Determination of Gaseous Fuels by Gas Chromatography, 2005). However, this auto calibration may not be designed to detect systematic shifts in the response factors. If the response factor increases or decreases consistently after every calibration, and the deviation of the new response factor from the previous response factor is still within the acceptable deviation limit, no warning will generally be generated by the GC, and it may continue to function without reporting any faults.

Repeatability and reproducibility tests, for example, as specified by ASTM D1945:1996 (See for example, ASTM D1945, Standard Test Method for Analysis of Natural Gas by Gas Chromatography, 1996) or GPA 2261:1995 (See for example, GPA 2261, Analysis of Natural Gas and Similar Gaseous Mixtures by Gas Chromatography, 1995), may be useful indications of whether a GC is working within limits which are specified. However, due to the wide tolerance on some compounds, these tests may not guarantee that the GC is working as intended. For example, using these tests may not ensure that each of the components goes through its intended column, and further it may not confirm that all the valve timings are correct. Further analysis to check this functionality may be desired and this may be done by analyzing the response factor of each, component. One such technique involves plotting a response factor of various components in order of thermal conductivity of the components. Due to the high thermal conductivity properties of the carrier gas, a component with a relatively high thermal conductivity has a reduced effect on the carrier gas. Plotting the response factor of methane, nitrogen, ethane, CO₂, propane, i-butane, n-butane, neo-pentane, i-pentane, n-pentane, hexane+, and heptane+, etc., arranged from the highest thermal conductivity should give an increasing sequence of response factor values. A typical graphical representation of the results is shown in FIG. 2 at 200. If this sequence is not evident, then this may indicate that some form of incorrect setting on the GC.

The above-described techniques may be used as a basic verification of calibration results, but they may not be accurate in all conditions. In particular, the inventor has found that the techniques are sensitive to flow rate of the carrier gas through the gas chromatograph and valve timings.

### SUMMARY OF THE INVENTION

It is therefore an object of the present invention to provide a method of analyzing gas chromatography data, which at least mitigates one or more drawbacks of the previously proposed analysis techniques.

Furthermore, previous attempts at calibration do not adequately address the need to diagnose operational faults of gas chromatography equipment in response to analyzed data. It is therefore an object of the present invention to provide methods of calibrating, monitoring, and/or maintaining gas chromatography equipment which at least mitigate one or more drawbacks of the previously proposed techniques. Another aim of the invention is provide a method of performing gas chromatography analysis with improved accuracy compared with previously proposed methods.

Additional aims and objects of the invention will become apparent from reading the following summary of the invention and detailed description of its embodiments.

According to a first aspect, a method of analysing gas chromatography data may include receiving response factor data acquired from a gas chromatograph apparatus for each of a plurality of compounds included in one or more calibration gas samples. The method may also include receiving molecular weight data for each of the plurality of compounds, determining a correlation between the response factor data and the molecular weight data, and analyzing the correlation to determine a condition of the gas chromatograph apparatus.

The inventor has observed that in GC applications where pressure, temperature, and flow rate can be maintained constant, there may a very high correlation between the molecular weight of the saturated gas components and their response factor. This correlation may be used to determine an operating condition of the gas chromatograph, for example, whether it is operating in a healthy condition, in which response factor readings may be an accurate representation of the constituents in a gas sample, or an unhealthy condition, in which the response factor readings may be inaccurate.

The method may comprise performing a linear regression analysis of the response factor data and the molecular weight data. The linear regression analysis may be a simple linear regression, for example, by the ordinary least squares or other least squares method.

The method may comprise calculating a coefficient of determination (R²) of the response factor data and the molecular weight data, and comparing the coefficient of determination with a predetermined threshold. The coefficient of determination may, for example, be derived from a correlation coefficient such as Pearson's correlation coefficient. The threshold may be selected to have a numerical value greater than 0.95, but preferably may have a numerical value greater than 0.99.

The inventor has also recognized that with a three column GC, flow rate is generally not constant between operating phases before and after valve actuation, and this has an impact on the correlation between the molecular weight of the saturated gas components and their response factors. The use of restrictor tubing to regulate carrier gas flow to maintain and achieve the close-to-constant flow rate during valve actuation operations may be used with embodiments.

However, with pressure and temperature maintained generally constant, and with a restrictor tubing in place, slight flow rate differences may occur that may affect the response of thermal conductivity detector. The fluctuations in flow rate (as well as pressure and temperature) reduce the correlation of the molecular weight of each component with its response factor. The method therefore comprises dividing the response factor data into a first data set corresponding to a first subset of the plurality of compounds in the one or more calibration gas samples, and a second data set corresponding to a second subset of the plurality of compounds in the one or more calibration gas samples.

The first subset of the plurality of compounds may comprise compounds detected by the gas chromatography apparatus during a first operative phase of the gas chromatography apparatus, and the second subset of the plurality of compounds may comprise compounds detected by the gas chromatography apparatus during a second operative phase of the gas chromatography apparatus. The first and/or second operative phases may be first and/or second flow regimes in the gas chromatography apparatus. Preferably, the first operative phase is prior to the actuation of a valve in the gas chromatography apparatus, and the second operative phase is after the actuation of the valve (which the inventor has observed has affected the flow rates), or with the valve actuation configured differently.

The method may comprise determining a first correlation between the response factor data and the molecular weight data for the first data set, and may further comprise determining a second correlation between the response factor data and the molecular weight data for the second data set. Preferably, the method may comprise performing a linear regression analysis of the response factor data and the molecular weight data for one or both of the first and second data sets. More preferably, the method may comprise calculating a coefficient of determination of the response factor data and the molecular weight data for one or both of the first and second data sets and comparing the or each coefficient of determination with a predetermined threshold. Dividing the data into groups before analysis may have the advantage of avoiding cumbersome techniques for rectifying the flow rate, which may involve the fitting and/or adjustment of restrictor tubing to physically alter the flow rate through successive columns of the GC in different phases of operation.

With any of the above embodiments, comparing the or each coefficient of determination with a predetermined threshold may be indicative of a healthy or unhealthy condition of the gas chromatography apparatus, and the method may comprise outputting a corresponding signal. The method may comprise generating a report of the condition of the gas chromatography apparatus, and may comprise generating a graphical representation of the correlation and displaying the graphical representation to a user.

The method may comprise comparing the response factor data with an historical response factor data set (referred to as “footprint data”) which may be, for example, acquired from the gas chromatography apparatus, using the methods of the present embodiments, when the gas chromatography apparatus is known to be in a healthy condition. An example of a known healthy condition is after a multilevel calibration. However, multilevel calibrations may not always be possible, and footprint data may be acquired at other times. Data acquired using the methods of the present embodiments which indicates a good R₂ value (for example, very close to 1) and indicates good repeatability (for example, the unnormalized sum of the measured percentage compositions of all compounds in the gas calibration sample may be very close to 100%, and measured deviation of each compound may be less than the ASTM D1945:1996 (See for example, ASTM D1945, Standard Test Method for Analysis of Natural Gas by Gas Chromatography, 1996) standard specification), may be designated as footprint data for the purposes of later analysis.

The method may further comprise analyzing the molecular weight data and the response factor data to diagnose one or more faults in the operation of the gas chromatography apparatus. In particular, the method may comprise one or more steps of the method according to the second aspect or its embodiments, as defined below.

According to a second aspect a method of diagnosing a fault of a gas chromatography apparatus may include receiving from the gas chromatograph apparatus, response factor data for each of a plurality of compounds contained in one or more calibration gas samples, and acquiring molecular weight data for each of the plurality of compounds. The method may also include determining a correlation between the response factor data and the molecular weight data, and analyzing the correlation to diagnose one or more faults in the operation of the gas chromatography apparatus.

The method may include comparing the measured response factor data for a particular compound with its theoretical value from the determined correlation. The method may include comparing the measured response factor data with historical or footprint response factor data acquired from the gas chromatography apparatus in a known healthy condition.

As with the first aspect, the method may comprise calculating a coefficient of determination of the response factor data and the molecular weight data, and comparing the correlation coefficient with a predetermined threshold. The coefficient of determination may be based on a correlation coefficient such as Pearson's correlation coefficient. The threshold may be selected to have a numerical, value greater than 0.95, but may preferably have a numerical value greater than 0.99.

The method may comprise dividing the response factor data into a first data set corresponding to a first subset of the plurality of compounds in the one or more calibration gas samples, and a second data set corresponding to a second subset of the plurality of compounds in the one or more calibration gas samples. The method may comprise determining a first correlation between the response factor data and the molecular weight data for the first data set, and may further comprise determining a second correlation between the response factor data and the molecular weight data for the second data set. The method may include performing the comparison steps outlined above for both of the first and second response factor data sets.

The one or more faults may comprise a valve actuation timing fault, and the method may additionally comprise correcting the valve actuation time in response to the detected fault. In particular, the method may comprise one or more steps of the method according to the third aspect or its embodiments, as defined below. Embodiments of the second aspect may include one or more features of the first aspect of the invention or its embodiments, or vice versa.

According to a third aspect a method of configuring a gas chromatography apparatus may include diagnosing an operating faults by an analysis of a correlation between response factor data acquired in the gas chromatography and molecular weight data for each of a plurality of compounds in one or more calibration gas samples, and generating an output signal indicative of the operating fault. The method may include adjusting an operating parameter of the gas chromatography apparatus in response the output signal.

The operating fault may comprise a valve actuation timing fault, and the method may additionally comprise correcting the valve actuation time in response to the output signal. The valve actuation may be a valve actuation which allows back-flushing of the heaviest component in the calibration gas. Alternatively, or in addition, the valve actuation may trap light components in the calibration gas in a column of the gas chromatograph. Alternatively, or in addition, the valve actuation may allow light components to leave a column of the gas chromatograph.

The adjustment of the operating parameter may be effected by an operator intervention, or may be effected automatically in response to the output signal. Embodiments of the third aspect may include one or more features of the first or second aspects of the invention or its embodiments, or vice versa.

According to a fourth aspect, a computerized method of analysing gas chromatography data may include receiving in a computer system, response factor data acquired from a gas chromatography apparatus. The response factor data may be representative of the proportions of each of a plurality of compounds contained in one or more calibration gas samples. The method may further include receiving in the computer system molecular weight data for each of the plurality of compounds, processing with the computer system the response factor data and molecular weight data to determine a correlation between the response factor data and the molecular weight data, and analyzing with the computer system the correlation to determine a condition of the gas chromatography apparatus.

The method may also include outputting a signal from the computer system, the signal being indicative of the condition of the gas chromatography apparatus. Embodiments of the fourth aspect may include one or more features of any of the first to fourth aspects of the invention or its embodiments, or vice versa.

According to a fifth aspect a method of diagnosing a fault of a gas chromatography apparatus, may include receiving from the gas chromatograph apparatus response factor data for each of a plurality of compounds contained in one or more calibration gas samples. The method may also include receiving molecular weight data for each of the plurality of compounds, determining a correlation between the response factor data and the molecular weight data, and analyzing the correlation to diagnose one or more faults in the operation of the gas chromatography apparatus.

Analysing the correlation may include comparing the measured response factor data for at least one particular compound with its theoretical value from the determined correlation, and calculating a coefficient of determination of the response factor data and the molecular weight data and comparing the correlation coefficient with a predetermined threshold. Embodiments of the fifth aspect may include one or more features of any of the first to fourth aspects of the invention or its embodiments, or vice versa.

According to a sixth aspect, a method of diagnosing a fault of a gas chromatography apparatus, may include receiving from the gas chromatograph apparatus retention time data for each of a plurality of compounds contained in one or more calibration gas samples. The method may also include comparing the retention time data with historical retention time data acquired from the gas chromatograph apparatus for each of the plurality of compounds to diagnose one or more faults in the operation or condition of the gas chromatography apparatus.

According to a seventh aspect, a computer readable storage medium may store instructions which, when executed on a programmed processor, carry out the methods of any of the first to sixth aspects of the invention. According to an eighth aspect, a computer system may be programmed to carry out the methods of any of the first to sixth aspects. The methods of the various aspects of the invention and/or the critical steps thereof are preferably implemented in software, although it will be understood that the methods or steps thereof may also be implemented in firmware or hardware or in combinations of software, firmware, or hardware.

### BRIEF DESCRIPTION OF THE DRAWINGS

There will now be described, by way of example only, various embodiments of the invention with reference to the drawings, of which:

FIG. 1 is a schematic diagram of a typical three-column gas chromatograph in accordance with the prior art;

FIG. 2 is a graph of response factor data plotted for compounds according to their increasing thermal conductivity in accordance with the prior art;

FIG. 3 is a flow diagram of a method according to a first embodiment of the invention;

FIG. 4 is a graph of response factor data for a gas chromatograph having similar flow regimes in different phases of operation;

FIG. 5 is a graph of response factor data for a gas chromatograph having different flow regimes in different phases of operation;

FIG. 6 is a flow diagram of a method according to an embodiment of the invention, in which response factor data is correlated to molecular weight for different compound groups;

FIGS. 7A and 7B are graphs of response factor data versus molecular weight for different groups of compounds;

FIGS. 8A to 8C are chromatographs depicting analyzed data against historical footprint data;

FIG. 9 is a flow diagram of a method for diagnosing faults of a gas chromatograph according to a further embodiment of the invention;

FIGS. 10 to 13 are graphs of the analysis of correlation data according to examples of the method of FIG. 9.

### DETAILED DESCRIPTION OF PREFERRED EMBODIMENTS

By way of example only, embodiments of the invention are described in applications of gas chromatography to the analysis of hydrocarbon including gas samples, for example, natural gas samples. Applications to C₆+ GC systems and C₇+ GC systems are described, but the invention is not so limited and its principles may be applied to other GC systems. The embodiments are generally described as being implemented in a computer system, and it will be appreciated that the invention may be implemented in software, hardware, firmware, or a combination thereof.

Referring firstly to FIG. 3, a flow diagram representing steps of a method 300 in accordance with a first embodiment is illustrated. The method 300 uses the realization that there is a correlation between the response factor of a compound in a gas sample and its molecule weight, and applies this to the analysis of a condition of a GC apparatus to generate a healthy or unhealthy signal to an operator.

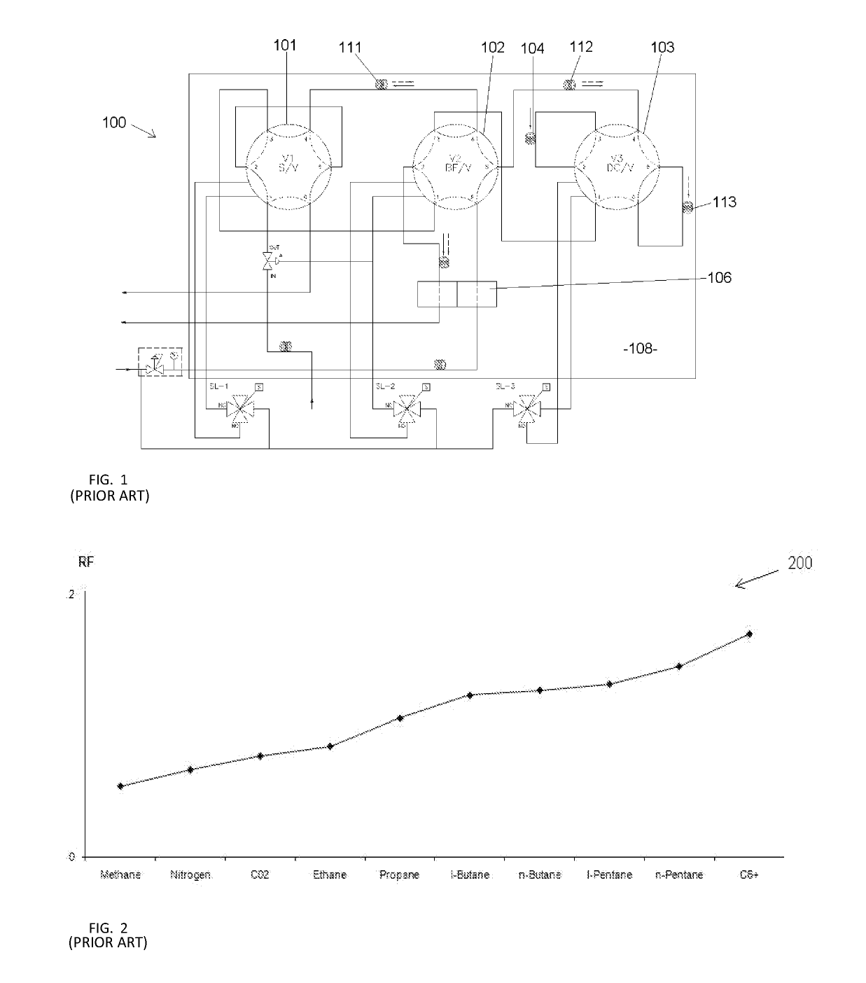

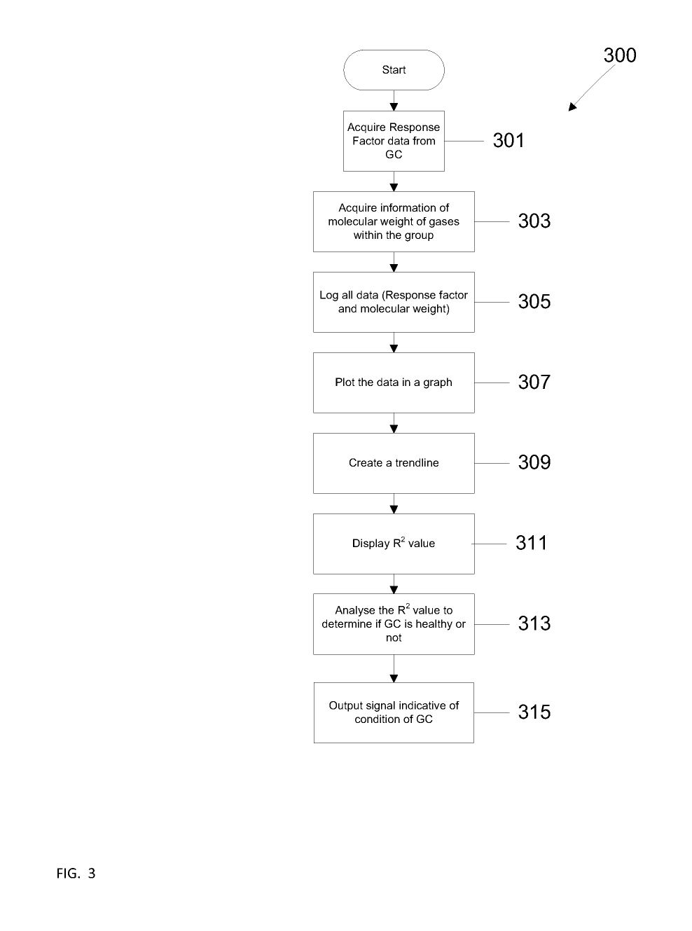

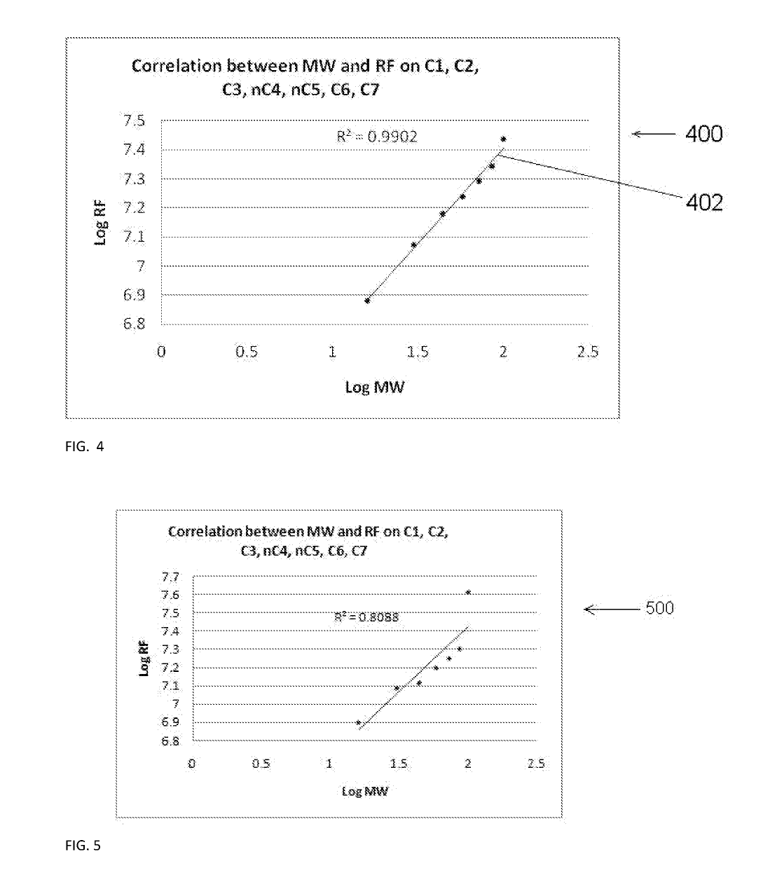

The method starts by acquiring (step 301) response factor data from a three-column GC apparatus, such as that described with reference to FIG. 1. The response factor data (RF) is calculated by analysis of a gas sample including a known (certified) composition of hydrocarbons and inert gases, and the data is received in a computer system, which may be a personal computer programmed to execute the steps of the method. The computer system may be interfaced with the GC, although the method may also be performed using data collected and stored from a GC at an earlier time. Molecular weight data (MW) may be known for the constituent compounds and is input into the computer system at step 303. Logarithms of the response factor data and the molecular weight data are calculated at step 305, and are plotted (step 307) to generate a graph of the logarithms of the response factor data versus the logarithms of the molecular weight data. FIG. 4 shows a graph 400 of Log (RF) (y-axis) against Log(MW) (x-axis) in a C₇+ GC system.

At step 309, a trend line 402 is generated by performing a linear regression analysis on the data. The linear regression analysis of this embodiment is a simple linear regression of the form y₁=mx+c using the ordinary least squares method. The linear regression calculation is performed by the formulae:

$$m = \frac{( n \sum xy - \sum x \sum y )}{( n \sum ( {x}^{2} ) - {( \sum x )}^{2} )} and c = \frac{( \sum y - m \sum x )}{n}$$

where:
x=Log(MW);
y=Log(RF); and
n=number of parameters.
The trend line is therefore represented by y₁=mx+c where:
m=gradient of the linear regression calculation;
c=constant of linear regression calculation; and
y₁=value of the line of the linear regression when Log (MW) is input as x in the linear regression equation. It will be appreciated that other correlation methods may be used in alternative embodiments.

The method also calculates and outputs (step 311) a coefficient of determination (R₂), which in this embodiment is the square of Pearson's correlation coefficient (R). For the graph 400 of FIG. 4, the coefficient of determination is 0.9902. The calculated R² value is compared (step 313) to a pre-programmed threshold value, which in this case is 0.99. The R² value is indicative of the degree of linearity in the response factor data, and therefore a relatively low value (i.e. below 0.99) indicates a poor correlation between the molecular weight and the response factor, which may be indicative of an operating fault in the GC apparatus. The operating fault may, in particular, be a valve timing error, which has resulted in one of the following scenarios: some of the heavy components leave the first column 111 and flow through the second column 112; some of the middle components are back-flushed together with the heavy components; some ethane is left in the second column 112, after valve 103 is actuated to trap the light components; some propane goes into the third column before valve 103 is actuated to trap the light components; and splitting of the first and last components on the column resulting in extraneous peaks on the chromatogram. If extraneous peaks are within the peak window of calibrated peaks they may be recognized as the calibrated peak.

The impact of these valve timing issues may affect the correlation of the components, and therefore an analysis of the R² value indicates that one or more of the above faults has occurred. Thus, according to this embodiment, the gas chromatography data is analyzed and transformed to produce an output signal indicative of a healthy condition of the GC.

The above-described method works adequately for a single column GC system or a three-column system where there may be a relatively consistent flow rate through the columns during different phases operation (i.e. after valve actuation). However, it may be rare to have consistent flow rates. FIG. 5 is a graph 500 of response factor data against molecular weight data for a GC system having different flow rates during different phases of operation. Following the method 300, the R² value is calculated to be 0.8088, and therefore the GC would be characterized to be unhealthy. However, it may be possible that the GC is in fact in a healthy condition, with the correlation due only to the difference in flow rates. It may be possible to make adjustments to the restrictor tubing to achieve a similar flow rate between the operating phases before and after the actuation of the valve 113. However, it may be time consuming and inaccurate to make adjustments to the restrictor tubing, and therefore preferred embodiments may reduce inaccuracies due to the varying flow rates by treating the different operation phases separately. Temperature and pressure conditions in the different phases of operation may also impact the response factor correlation.

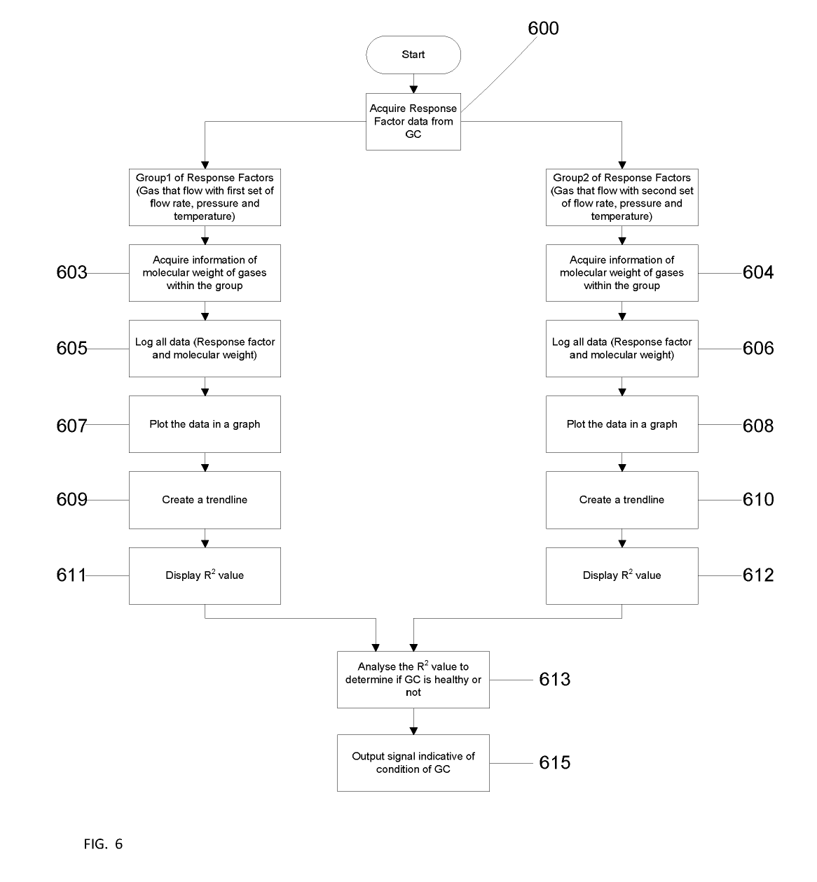

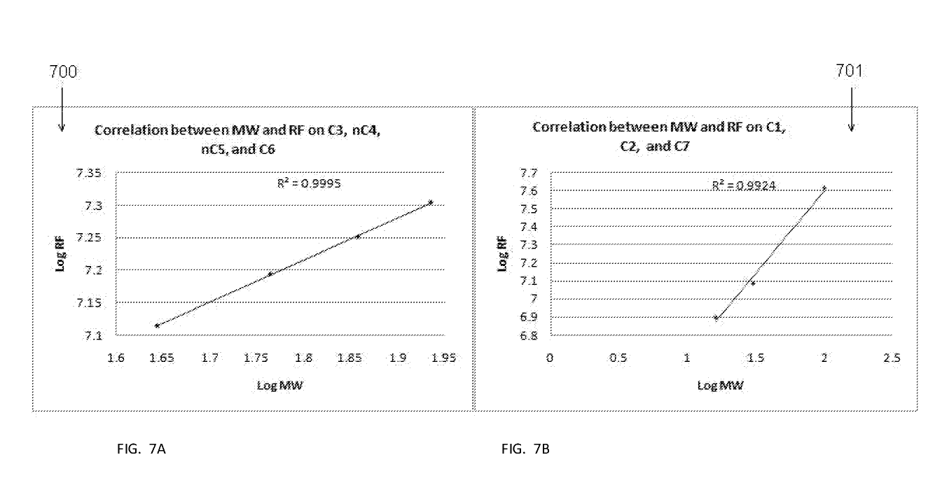

FIG. 6 is a flow diagram representing steps of a method 600 in accordance with a second embodiment. The method 600 is similar to the method 300 described above, but divides the response factor data into a first and second data sets. The first data set corresponds to a group of compounds which are detected in a first phase of operation, with a first flow rate, pressure, and temperature. The second data set corresponds to those compounds detected in a second phase of operation, with a second flow rate, pressure and temperature. The first and second phases of operation are defined by any change in conditions in the GC, but, in particular, by the actuation of a valve, which changes the flow path and therefore the flow rate through the GC.

The steps of the method 600 are the same as those steps in method 300, with like steps indicated by like reference numerals incremented by 300. As before, a correlation between the response factor data and the molecular weight data may be determined and the coefficient of determination is calculated to determine a condition of the GC. However, in method 600 the same steps, labelled as 604, 606, 608, 610, 612, are performed separately on response factor data R² corresponding to the distinct compound groups to calculate a second correlation and a second R₂ value. The two R² values are compared to a preset threshold value (e.g. 0.99), and if either of the R² values fall beneath the threshold, then the GC may be characterized as unhealthy, and a corresponding signal is output from the computer system at step 615.

FIGS. 7A and 7B, respectively, show graphs 700, 701 of Log (RF) versus Log(MW) for the first and second compound groups for a C₇+ GC system. The first graph 700 plots Log (RF) versus Log(MW) for the middle compounds, C₃, nC₄, nC₅ and C₆ and shows a relatively strong correlation with an R² value of 0.9995. These are the compounds detected with valve 113 actuated to direct flow through the restrictor tubing of the GC. The second graph 701 plots Log(RF) versus Log(MW) for the light compounds C1, C2 and the heavy compounds, C7 and higher. Again the graph shows a relatively strong correlation, this time with an R² value of 0.9924. The GC apparatus may be characterized as healthy with both R² values exceeding the threshold. It is notable that performing the correlation calculation on the data as a single group would have resulted in a relatively poor R² value, which would have falsely indicated an operating fault.

The correlation method described above can be utilized more effectively if a historical “footprint” of the GC is taken when the conditions and operations were stable and the GC had recently been calibrated using a multilevel calibration. Data taken at a time when R² is measured to be very close to 1, good repeatability with the sum of the un-normalized percentages of all of the components in the gas sample is close to 100%, and deviation of each component of gas sample is within the ASTM D1945:1996 (See for example, ASTM D1945, Standard Test Method for Analysis of Natural Gas by Gas Chromatography, 1995) standard specification, may also be designated as footprint data. The latter may be utilized when the GC has been repaired and/or reconfigured and it is not possible to carry out a multilevel calibration, for example, where a column of the GC has been changed out on site. The so-called footprint data is acquired by the methods according to the present embodiments.

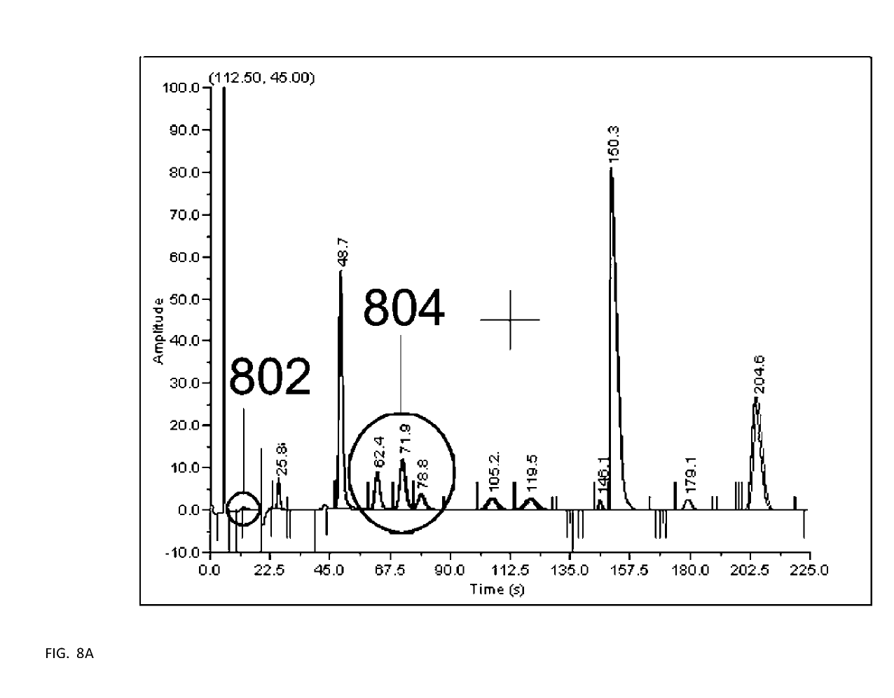

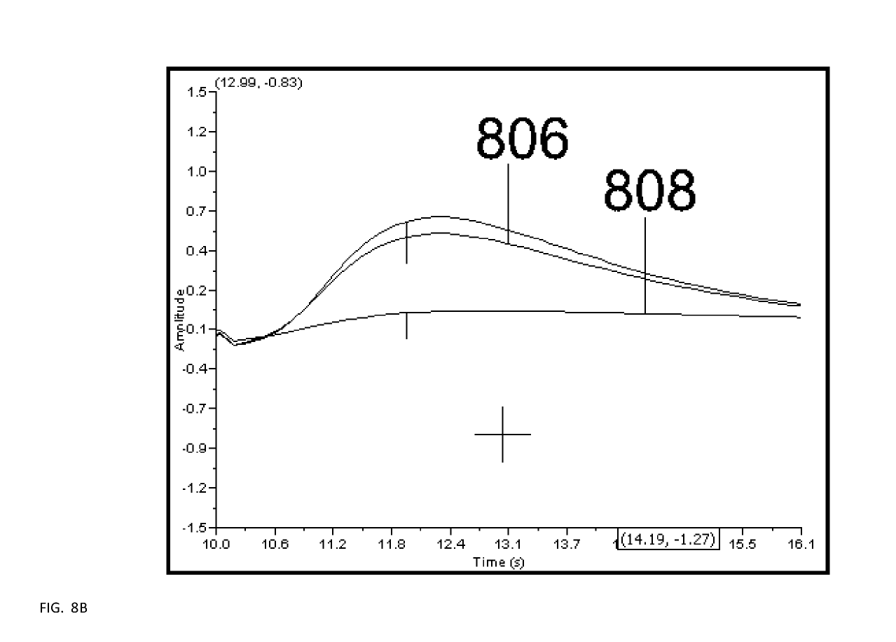

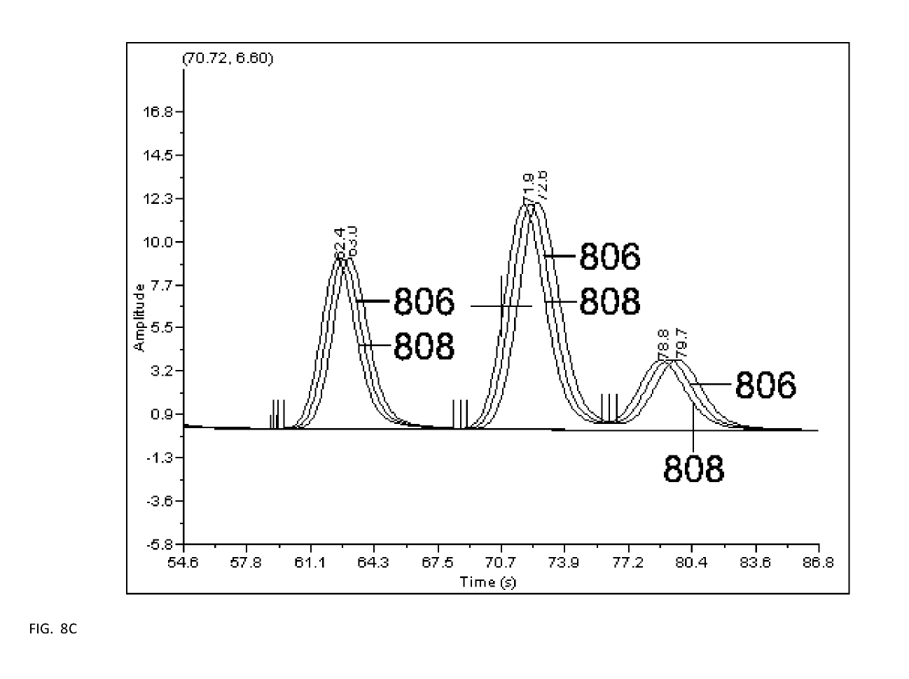

An example of a live test case of the use of correlation method, and footprint and historical data is described below. A chromatograph valve diaphragm was changed on a C₆+ GC system on a particular day (day one), and a chromatogram and calibration report was taken as a footprint data set two days later (on day three). The chromatograms shown in FIGS. 8A, 8B, and 8C show data from day three, approximately one year later, and approximately one year and two months later respectively. FIG. 8A shows the chromatogram for the analysis and footprint data of the GC tested. The circle 802 and circle 804 are where details of the faults are identified, and they are enlarged in FIG. 8B and FIG. 8C respectively.

From the chromatogram in FIG. 8B, the measured data (line 806) deviates from the footprint data (line 808). The retention times of components were also slower (relative moved to the right) than expected from the calibration report if the results were compared with the footprint calibration report. The RF of components generally went up, with C₆ having the highest shift of RF. Even with this deviation and slower retention times, the correlation analysis (by method 600) was still good. However, the increase of response factors of some components suggested that there was a change of the carrier gas flow rate which changed the response of the detector to each component. The shift of retention times was in fact caused by a port to port leak on the valve diaphragm on valve 102. The results suggested that the GC was moving from being in a healthy state to an unhealthy state. By analyzing this information, it may be determined when to intervene and perform maintenance on the GC system before it enters an unhealthy state.

The methods described herein use the footprint information generated when the GC is known to be functioning correctly. Data such as oven temperature, carrier gas pressure, carrier gas flow rate, response factor, etc. are recorded and the response factor and correlation between response factor and molecular weight is plotted. These footprint values can be used as a tool to analyze day-to-day calibration results. This is in contrast to the prior art techniques, which only compares calibration data on day to day basis, with the previously described limitations.

The reports generated by the software in the methods may use the footprint data as the initial configuration data set. When generating the report, the software compares the current calibration data to the footprint by overlaying plots of the data from the footprint, with the plot from current calibration. With the graphical representation, a drift in response factor from the footprint data can be seen. A trend is generated of the error between each component response factors for selected dates and the footprint data. Based on this error analysis, the drift in response factor may be trended. Further statistical methods can be used to analyze the error data.

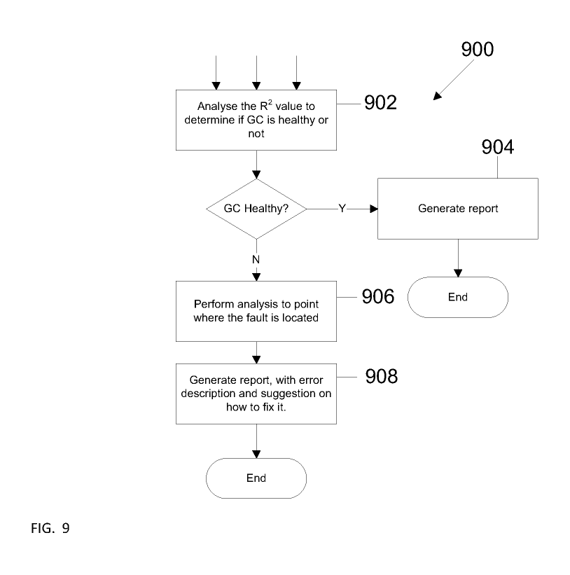

The methods 300, 600 described above may be extended to provide further analysis for the purposes of diagnosing operating faults of the GO apparatus. FIG. 9 is a flow diagram of a method, generally shown at 900, for the diagnosis of a fault. The method 900 may be preceded by the methods 300 or 600, and for the purposes of the following examples will be considered to follow the method 600.

The R² values for the respective groups of compounds are calculated and used to determine (at step 902) the healthy or unhealthy condition of the GC. If the GC is considered to be healthy, with both R² values exceeding the preset thresholds, then a report is generated (step 904) which may be presented on a visual display to a user and/or stored for later review before the method ends.

If however the GC is characterized as unhealthy, i.e. one or both of the R² values is beneath the threshold, the computer system may perform additional analysis on the calculated correlation (step 906) to diagnose the fault. A report of the fault is generated (step 908) along with a suggested remedy for the fault.

### Example 1

A first example is described with reference to FIGS. 10A and 10B, which are graphs 1000, 1001 of the Log(RF) data versus Log(MW) data for respective compound groups in a C₇+ system. A comparison of the RF data for the C₇ compound reveals the following: Log(RF_{C}_{₇})<y_{1C}_{₇} (i.e. the measured data is below the trend line); Log(RF_{C}_{₇})<Log(RF_{C}_{₇}_{(footprint)}) (i.e. the measured data is less than the corresponding footprint data); Log(RF) data for other compounds are similar to their respective footprint data (i.e. within a predetermined tolerance, such as 1%); and R² for the C₁-C₂-C₇ chart is less than a set threshold (normally set to 0.99).

This result can be explained by some of the heavy compounds leaving the first column 111, and flowing through column 112. This reduces the measured response factor of the heaviest component (C7+). The fault is due to a valve timing error on valve 102; it is actuating too late, and the fault can be addressed by decreasing the valve actuation time.

It will be appreciated that the same analysis can be performed on a C₆+ system, although in such a case the C₆ data point is analyzed.

### Example 2

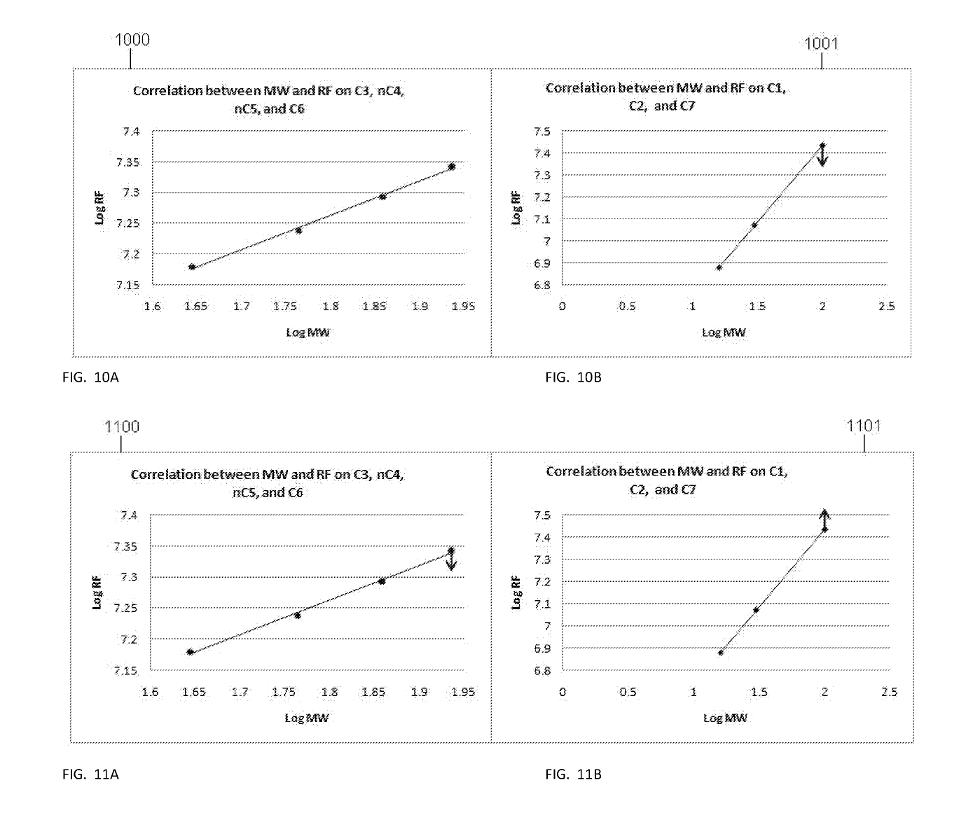

A second example is described with reference to FIGS. 11A and 118, which are graphs 1100, 1101 of the Log(RF) data versus Log(MW) data for respective compound groups in a C₇+ system. A comparison of the RF data for the C₆ and C₇ compounds reveals the following:

Log(RF_{C}_{₆})<y_{1C}_{₆} (i.e. the measured data is below the trend line) Log(RF_{C}_{₆})<Log(RF_{C}_{₆}_{(footpring)}) (i.e. the measured data is less than the corresponding footprint data);
Log(RF_{C}_{₇})>y_{1C}_{₇} (i.e. the measured data is above the trend line); Log(RF_{C}_{₇})>Log(RF_{C}_{₇}_{(footprint)}) (i.e. the measured data is greater than the corresponding footprint data); Log(RF) data for other compounds are similar to their respective footprint data (i.e. within a predetermined tolerance, such as 1%); and R² for the C₁-C₂-C₇ chart and the C₃-nC₄-nC₅-nC₆ is less than a set threshold (normally set to 0.99).

This result may be explained by some of the middle components being back-flushed together with the heavy component. This increases the measured response factor of the heaviest component (C₇+), and the heaviest of the middle components (C₆) has a lower response factor than expected. The fault is due to a valve timing error on valve 102. It may be actuating too soon, and the fault may be addressed by increasing the valve actuation time. It will be appreciated that the same analysis can be performed on a C₆+ system, although in such a case the C₆ data point is analysed.

### Example 3

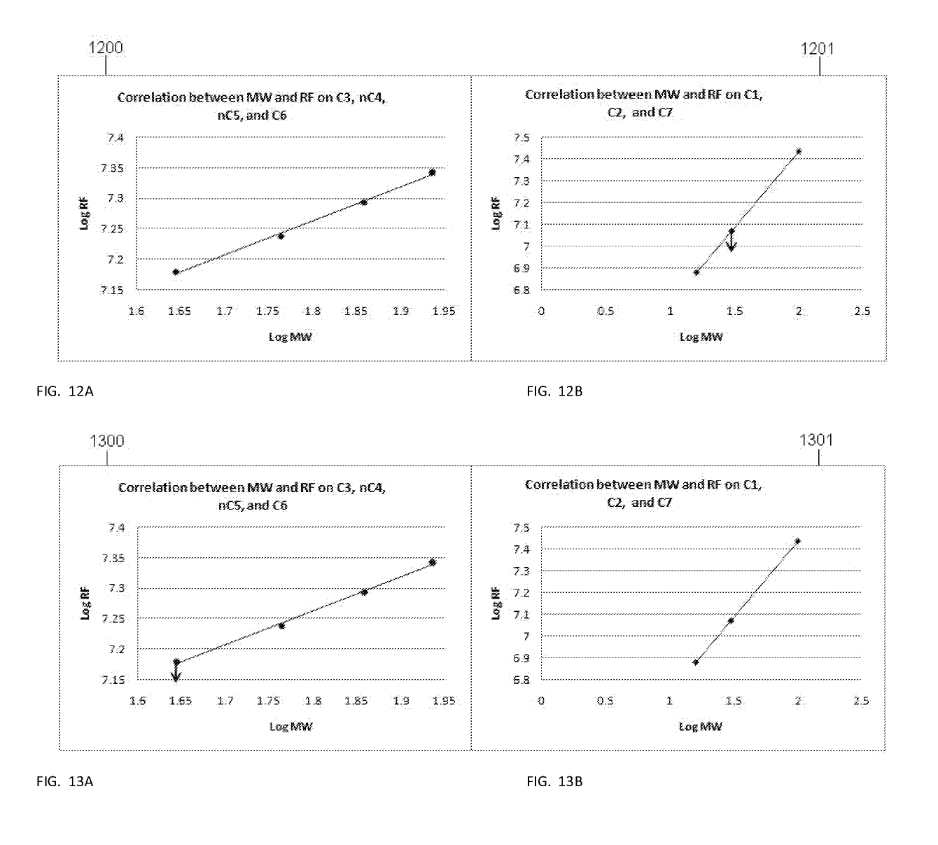

A third example is described with reference to FIGS. 12A and 12B, which are graphs 1200, 1201 of the Log(RF) data versus Log(MW) data for respective compound groups in a C₇+ system. A comparison of the RF data for the C₂ compound reveals the following: Log(RF_{C}_{₂})<y_{1C}_{₂} (i.e. the measured data is below the trend line); Log(RF_{C}_{₂})<Log(RF_{C}_{₂}_{(footpring)}) (i.e. the measured data is less than the corresponding footprint data); Log(RF) data for other compounds are similar to their respective footprint data (i.e. within a predetermined tolerance, such as 1%); R² for the C₁-C₂-C₇ chart is less than a set threshold (normally set to 0.99); and R² for the C₃-C₄-C₅-C₆ chart is greater than a set threshold (normally set to 0.99).

This result can be explained by some ethane being left in the second column 112, after the actuation of valve 113 to trap the light compounds. This reduces the measured response factor of the ethane (C₂). The fault is due to a valve timing error on valve 103; it is actuating too soon, and the fault can be addressed by increasing the valve actuation time it will be appreciated that the same analysis can be performed on a C₆+ system.

### Example 4

A fourth example is described with reference to FIGS. 13A and 13B, which are graphs 1300, 1301 of the Log(RF) data versus Log(MW) data for respective compound groups in a C₇+ system. A comparison of the RF data for the C₃ compound reveals the following: Log(RF_{C}_{₃})<y_{1C}_{₃} (i.e. the measured data is below the trend line); Log(RF_{C}_{₃})<Log(Rf_{C}_{₃}_{(footprint)}) (i.e. the measured data is less than the corresponding footprint data); Log(RF) data for other compounds are similar to their respective footprint data (i.e. within a predetermined tolerance, such as 1%); R² for the C₁-C₂-C₇ chart is greater than a set threshold (normally set to 0.99); and R² for the C₃-C₄-C₅-C₆ chart is less than a set threshold (normally set to 0.99).

This result can be explained by some propane passing to the third column before the actuation of valve 113 to trap the light compounds. This reduces the measured response factor of the propane (C₃). The fault is due to a valve timing error on valve 103; it is actuating too late, and the fault can be addressed by decreasing the valve actuation time. It will be appreciated that the same analysis can be performed on a C₆+ system.

The above-described methods may be extended to include a step of adjusting the GC system, for example, to change a valve actuation time. In embodiments, the adjustment may be performed as a manual configuration step by an operator after the diagnosed fault has been determined and reported. In alternative embodiments, the method includes the step of automatically adjusting an operating parameter of the GC apparatus (such as valve timing) in response to a signal indicative of the diagnosed fault. Thus, a configuration or adjustment signal may be generated by the computer system and received by the GC apparatus.

The methods may be extended to diagnose a valve leak condition or a back pressure of a vent of the gas chromatograph as follows. Where a valve leak or back pressure is present, there may not be a significant effect on the calculated R² value, and therefore the method 900 may indicate a healthy condition of the GC. An extended method includes the step of comparing retention time data with historical retention time data (or footprint data), or where available, a retention time trend is analysed using several historical data sets.

Where the measured retention time data for each component is generally greater than the footprint retention time data, or where the trend is for the retention time to increase, then it can be inferred that one of the following scenarios has occurred: The measurement vent of the GC is providing an unexpected back pressure which has the effect of reducing the flow rate in the system; or A port to port leak has occurred in the GC due to a leak at a valve, which causes some of the gas flow to be separated into two path when it passes through the valve, reducing the flowrate of the components within system. Therefore the increase in retention time with respect to historical retention time data allows a measurement vent fault or a valve fault to be diagnosed.

The nature of the fault can be verified by analyzing response factor (RF) data for each of the components of a gas sample. For each component, response factor is compared to the response factor for the footprint data, or where available, a response factor trend is analysed using several historical data sets. Where the measured response factor is greater for the majority of components in comparison to the footprint data, or where the trend is for the response factor to increase, this indicates a valve in the GC is leaking. The valve leak can be assessed, reconfigured and/or repaired, for example, by replacing the valve diaphragm.

Furthermore, retention time data can be used to identify the most likely valve fault. If the retention time shift only happens on the lightest components (N_{I}, C₁, CO₂, C₂) then it is most likely the leak is in valve 113. However, if the retention time shift happens for middle and light components, then it is most likely that the leak is on valve 112.

Where the measured response factor data is generally lower than the footprint response factor data, then it may be inferred that there is a measurement vent back pressure. The GC can then be assessed, reconfigured and/or repaired by identifying and removing the source of the back pressure. This cause may also be indicated be an upward shift in retention times for middle and light components of the gas sample (where the response factor data is lower than the footprint data).

A further application of the correlation methods described above is when a calibration gas is to be replaced. The footprint and the historical data can be used to ensure that the certificate and calibration for the new reference is correct. Before a new calibration or reference gas bottle is replaced, the last calibration data of the GC may be checked. When the calibration data is good, then the calibration gas to be changed should be analyzed to ensure that the composition determined by the GC is within acceptable deviation limits of the calibration gas certificate. Once the reading has stabilized, a calibration may be performed using the new calibration gas.

The calibration results, the shifts from the footprint data, and the shifts from the last calibration result may be used in the correlation software to confirm the validity of the new calibration. Further investigation may be done based on the analysis of this data if the calibration result is not satisfactory.

The embodiments provide a computerized method of analysing gas chromatography data. Response factor data for each of a plurality of compounds included in one or more calibration gas samples is acquired from a gas chromatograph apparatus, and a correlation with molecular weight data for each of the plurality of compounds is determined using a computer system. The correlation can be analyzed to determine a condition of the gas chromatograph. Preferred embodiments determine a correlation for each of a plurality of operating phases of the gas chromatograph, for example, before and after actuation of valves which change the flow rate. Methods of diagnosing faults, calibrating and configuring gas chromatographs are also described.

The present embodiments address shortcomings of previously proposed analysis techniques. In particular, the method provides an accurate calibration of a gas chromatography apparatus without relying on a multilevel calibration. The embodiments also facilitate the diagnosis and rectification of operational faults of gas chromatography equipment in response to analyzed data.

Various modifications may be made within the scope of the invention as herein intended, and embodiments of the invention may include combinations of features other than those expressly claimed. Although embodiments of the invention are described with reference to three-column gas chromatographs, the principles of the invention can be applied to other types of gas chromatography system.

1-29. (canceled)

30. A method of analyzing gas chromatography data comprising:
receiving in a computer system response factor data acquired from a gas chromatograph apparatus for each of a plurality of compounds included in at least one calibration gas sample;
receiving in the computer system molecular weight data for each of the plurality of compounds;
using the computer system to determine a correlation between the response factor data and the molecular weight data; and
analyzing the correlation to determine a condition of the gas chromatograph apparatus.

31. The method as claimed in claim 30 wherein using the computer to determine the correlation comprises using the computer to perform a linear regression analysis of the response factor data and the molecular weight data.

32. The method as claimed in claim 30 wherein using the computer to determine the correlation comprises using the computer to calculate a coefficient of determination of the response factor data and the molecular weight data and wherein analyzing the correlation comprises comparing the coefficient of determination with a predetermined threshold.

33. The method as claimed in claim 30 further comprising dividing the response factor data into a first data set corresponding to a first subset of the plurality of compounds included in the at least one calibration gas sample, and a second data set corresponding to a second subset of the plurality of compounds contained in the at least one calibration gas sample.

34. The method as claimed in claim 33 wherein the first subset of the plurality of compounds comprises compounds detected by the gas chromatography apparatus during a first operative phase of the gas chromatography apparatus, and the second subset of the plurality of compounds comprises compounds detected by the gas chromatography apparatus during a second operative phase of the gas chromatography apparatus.

35. The method as claimed in claim 34 wherein at least one of the first and second operative phases correspond respectively to at least one of first and second flow regimes in the gas chromatography apparatus.

36. The method as claimed in claim 35 wherein the first operative phase is prior to the actuation of a valve in the gas chromatography apparatus, and the second operative phase is after the actuation of the valve.

37. The method as claimed in claim 33 wherein using the computer to determine a correlation between the response factor data and the molecular weight data comprises using the computer to determine a first correlation between the response factor data and the molecular weight data for the first data set.

38. The method as claimed in claim 33 wherein using the computer to determine a correlation between the response factor data and the molecular weight data comprises using the computer to determine a second correlation between the response factor data and the molecular weight data for the second data set.

39. The method as claimed in claim 33 wherein using the computer to determine a correlation between the response factor data and the molecular weight data comprises performing a linear regression analysis of the response factor data and the molecular weight data for one or both of the first and second data sets, calculating a coefficient of determination of the response factor data and the molecular weight data; wherein analyzing the correlation comprises comparing the coefficient of determination with a predetermined threshold; and wherein the result of comparing the or each coefficient of determination with a predetermined threshold is indicative of a healthy or unhealthy condition of the gas chromatography apparatus.

40. The method as claimed in claim 30 further comprising outputting a signal indicative of a healthy or unhealthy condition of the gas chromatography apparatus.

41. The method as claimed in claim 30 further comprising generating a report of a healthy or unhealthy condition of the gas chromatography apparatus.

42. The method as claimed in claim 30 further comprising generating a graphical representation of the correlation and displaying the graphical representation to a user.

43. The method as claimed in claim 30 wherein analyzing the correlation comprises comparing the response factor data with a historical response factor data set, wherein the historical response factor data set is acquired from the gas chromatography apparatus in a known healthy condition.

44. The method as claimed in claim 30 wherein analyzing the correlation comprises comparing retention time data with historical retention time data.

45. The method as claimed in claim 30 wherein analyzing the correlation comprises analyzing the molecular weight data and the response factor data to diagnose at least one fault in at least one of operation and condition of the gas chromatography apparatus.

46. The method as claimed in claim 30 wherein analyzing the correlation comprises analyzing retention time data to diagnose at least one fault on at least one of operation and condition of the gas chromatography apparatus.

47. A method of diagnosing a fault of a gas chromatography apparatus, the method comprising:
receiving in a computer system response factor data acquired from the gas chromatograph apparatus for each of a plurality of compounds included in at least one calibration gas sample;
receiving in the computer system molecular weight data for each of the plurality of compounds;
using the computer system to determine a correlation between the response factor data and the molecular weight data; and
analyzing the correlation to diagnose at least one fault in at least one of operation and condition of the gas chromatography apparatus.

48. A method of configuring a gas chromatography apparatus comprising:
diagnosing an operating fault by an analyzing in a computer system a correlation between response factor data acquired from the gas chromatography and molecular weight data for each of a plurality of compounds included in at least one calibration gas sample;
generating an output signal from the computer system indicative of the operating fault;
adjusting an operating parameter of the gas chromatography apparatus in response the output signal.

49. The method as claimed in claim 48 wherein the operating fault comprises a valve actuation timing fault, and wherein adjusting the operating parameter of the gas chromatography apparatus comprises correcting a valve actuation time in response to the output signal.

50. The method as claimed in claim 49 wherein the valve actuation timing fault allows back-flushing of a heaviest component in the calibration gas.

51. The method as claimed in claim 49 wherein the valve actuation timing fault traps light components in the calibration gas in a column of the gas chromatograph.

52. The method as claimed in claim 49 wherein the valve actuation timing fault allows light components to leave a column of the gas chromatograph.

53. The method as claimed in claim 48 wherein the operating fault comprises a valve leak, and wherein the method further comprises repairing the valve leak.

54. The method as claimed in claim 48 wherein the operating fault comprises a measurement vent back pressure, and wherein adjusting the operating parameter of the gas chromatography apparatus comprises removing the source of the measurement vent back pressure.

55. The method as claimed in claim 48 wherein the adjustment of the operating parameter is effected by an operator intervention.

56. The method as claimed in claim 48 wherein the adjustment of the operating parameter is effected based upon a response to the output signal.

57. A non-transitory computer-readable medium comprising computer executable instructions for analyzing gas chromatography data, the computer-readable medium comprising instructions for:
receiving in a computer system response factor data acquired from a gas chromatograph apparatus for each of a plurality of compounds included in at least one calibration gas sample;
receiving in the computer system molecular weight data for each of the plurality of compounds;
using the computer system to determine a correlation between the response factor data and the molecular weight data; and
analyzing the correlation to determine a condition of the gas chromatograph apparatus.

58. The non-transitory computer-readable medium as claimed in claim 57 wherein using the computer to determine the correlation comprises using the computer to perform a linear regression analysis of the response factor data and the molecular weight data.

59. The non-transitory computer-readable medium as claimed in claim 57 wherein using the computer to determine the correlation comprises using the computer to calculate a coefficient of determination of the response factor data and the molecular weight data and wherein analyzing the correlation comprises comparing the coefficient of determination with a predetermined threshold.

60. A computer system for analyzing gas chromatography data, the computer system comprising:
a processor and memory coupled thereto;
said processor being configured to
receive response factor data acquired from a gas chromatograph apparatus for each of a plurality of compounds included in at least one calibration gas sample;
receive molecular weight data for each of the plurality of compounds;
determine a correlation between the response factor data and the molecular weight data; and
analyze the correlation to determine a condition of the gas chromatograph apparatus.

61. The computer system as claimed in claim 60 wherein said processor is configured to determine the correlation by performing a linear regression analysis of the response factor data and the molecular weight data.

62. The method as claimed in claim 60 wherein said processor is configured to determine the correlation by calculating a coefficient of determination of the response factor data and the molecular weight data, and wherein said processor is configured to analyze the correlation by comparing the coefficient of determination with a predetermined threshold.
